(19) United States
(12) Patent Application Publication
(10) Pub. No.: US 2013/0266160 A1
(43) Pub. Date: Oct. 10, 2013

(54) Coil

(71) Applicant: Jing He, Shenzhen (CN)

(72) Inventor: Jing He, Shenzhen (CN)

(73) Assignees: AAC MICROTECH (CHANGZHOU) CO.,LTD., Changzhou (CN); AAC ACOUSTIC TECHNOLOGIES (SHENZHEN) CO.,LTD., Shenzhen (CN)

(21) Appl. No.: 13/858,124

(22) Filed: Apr. 8, 2013

(30) Foreign Application Priority Data
Apr. 9, 2012 (CN) 201220147995.0

(51) Int. Cl. H04R 25/00

(52) U.S. Cl. CPC H04R 25/00
USPC 381/312

(57) ABSTRACT

A coil includes a first section, a second section spaced from the first section, a third section and a forth section connecting ends of the first and second sections for forming a closed loop. The third section includes a first portion directly contacting to the first section, and a second portion extending from the first portion and directly connecting to the second section, the first portion forms a protrusion away from the fourth section.

### 1. FIELD OF THE INVENTION

The present invention generally relates to the art of coils, more particularly to a hearing aid coil (HAC) used in a transducer for generating sound.

### 2. RELATED ART OF THE INVENTION

As the market of portable consumer electronic products growing, electronic devices like mini speaker are widely used, and speakers combining hearing aid function are more and more demanded by users who are hearing-impaired. Usually a hearing aid coil is mounted in a speaker and helps users wearing hearing aid hear sound by electromagnetic induction with audiphones. A coil is generally made by winding metal wire or laser etching.

General speakers are regular shaped like square or circle, but nowadays, shapes of speakers are tend to be irregular. A regular coil may adapt a speaker well when the speaker is also regular, but when the speaker has an irregular shape, the regular coil cannot adapt to the speaker and it will limit the size of the coil thereby limiting the performance of the speaker.

Accordingly, it is necessary to provide an improved coil for solving the problems mentioned above.

### BRIEF DESCRIPTION OF THE DRAWINGS

FIG. 1 is an illustrative top-view of a coil in accordance with a first exemplary embodiment of the present disclosure;

FIG. 2 is an illustrative top-view of a coil in accordance with a second exemplary embodiment of the present disclosure.

### DETAILED DESCRIPTION OF THE EXEMPLARY EMBODIMENTS

Reference will now be made to describe two exemplary embodiments of the present disclosure in detail.

The coil is assembled in a speaker especially for providing hearing impaired users with enhanced sound by electromagnetic induction between the coil and a hearing aid fitting into the user's ear.

### Embodiment 1

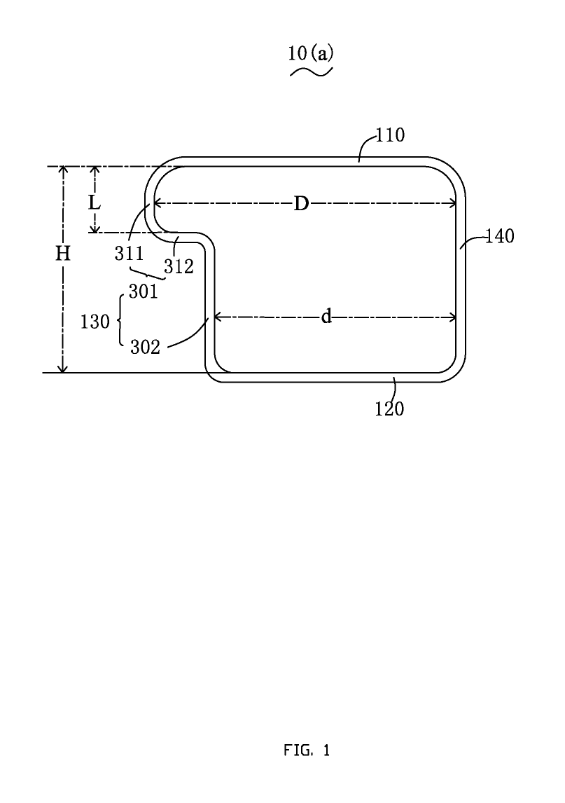

Referring to FIG. 1, a coil 10(a), in accordance with one exemplary embodiment of the present disclosure, includes a first section 110, a second section 120 spaced from the first section 110, a third section 130 and a forth section 140 connecting ends of the first and second sections for forming a closed loop. It's optional that the first section 110 is parallel to the second section 120.

The third section 130 includes a first portion 301 directly contacting to the first section 110, and a second portion 302 extending from the first portion 301 and directly connecting to the second section 120. The first portion 301 forms a protrusion away from the fourth section 140. Optionally, the first portion 301 includes a first part 311 substantially parallel to the forth section 140 and a second part 312 substantially perpendicular to the forth section 140. The second portion 302 is substantially parallel to the forth section 140. A distance between the first part 311 and the forth section 140 is defined as D, and a distance between the second portion 302 and the forth section 140 is defined as d. In this embodiment, D is larger than d. Alternatively, D may be smaller than d.

A length of the first part 311 is defined as L, and a distance between the first section 110 and the second section 120 is defined as H. In this embodiment, L is smaller than a half of H.

### Embodiment 2

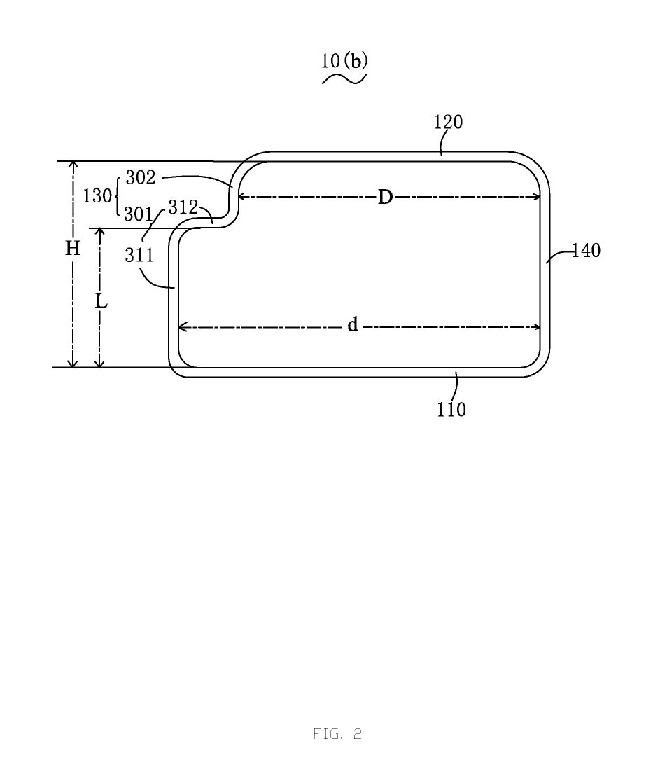

Referring to FIG. 2, a coil 10(b), in accordance with one exemplary embodiment of the present disclosure, includes a first section 110, a second section 120 spaced from the first section 110, a third section 130 and a forth section 140 connecting ends of the first and second sections for forming a closed loop. It's optional that the first section 110 is parallel to the second section 120.

The third section 130 includes a first portion 301 directly contacting to the first section 110, and a second portion 302 extending from the first portion 301 and directly connecting to the second section 120. The first portion 301 forms a protrusion away from the fourth section 140. Optionally, the first portion 301 includes a first part 311 substantially parallel to the forth section 140 and a second part 312 substantially perpendicular to the forth section 140. The second portion 302 is substantially parallel to the forth section 140. A distance between the first part 311 and the forth section 140 is defined as D, and a distance between the second portion 302 and the forth section 140 is defined as d. In this embodiment, D is larger than d. Alternatively, D may be smaller than d.

A length of the first part 311 is defined as L, and a distance between the first section 110 and the second section 120 is defined as H. In this embodiment, L is larger than a half of H. Optionally, L may be equal to a half of H.

When a speaker is irregular, coil 10(a) or coil 10(b) can adapt to the shape of the speaker, and maximize the coil thereby optimizing the performance of the speaker.

While the present invention has been described with reference to specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A coil for a transducer generating sound, comprising:
a first section;
a second section spaced from the first section;
a third section connecting two ends of the first and second sections;
a fourth section connecting the other two ends of the first and second sections for forming a closed loop; wherein
the third section includes a first portion directly contacting to the first section, and a second portion extending from the first portion and directly connecting to the second section, the first portion forms a protrusion away from the fourth section.

2. The coil as described in claim 1, wherein the first portion includes a first part substantially parallel to the forth section.

3. The coil as described in claim 2, wherein the second portion is substantially parallel to the forth section.

4. The coil as described in claim 3, wherein the distance between the first part and the forth section is larger than the distance between the third section and the forth section.

5. The coil as described in claim 1, wherein the length of the first part is smaller than a half of the distance between the first section and the second section.

6. The coil as described in claim 1, wherein the length of the first part is larger than a half of the distance between the first section and the second section.

7. A coil for a transducer generating sound, comprising:
a first section;
a second section substantially parallel to the first section;
a third section connecting two ends of the first and second sections;
a fourth section connecting the other two ends of the first and second sections for forming a closed loop; wherein
a selected section from the sections forms a protrusion extending away from another section opposed to the selected section.

8. The coil as described in claim 7, wherein the width of the protrusion is greater than half the width of the selected section.

9. The coil as described in claim 7, wherein the width of the protrusion is smaller than half the width of the selected section.
